(19) United States
(12) Patent Application Publication
(10) Pub. No.: US 2009/0202180 A1
(43) Pub. Date: Aug. 13, 2009

(54) ROTATION INDEPENDENT FACE DETECTION

(75) Inventor: Anders ERICSON, Lund (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/028,866

(22) Filed: Feb. 11, 2008

(51) Int. Cl. G06K 1/20

(52) U.S. Cl. 382/313; 382/312

(57) ABSTRACT

An image acquisition device includes an image sensing unit for registering raw image data and a movement sensing unit for determining information indicative of the current position of the image sensing unit and of a deviation of the current position of the image sensing unit from a reference position. The image sensing unit also includes a processing unit for receiving the information indicative of the current position of the image sensing unit and of its deviation from a reference position from the movement sensing unit. The processing unit is adapted for moving image data received from the image sensing unit to the current position by the amount of deviation from its reference position determined by the movement sensing unit and for performing object recognition on the thus moved image data.

### TECHNICAL FIELD

The present invention is related to the field of digital image acquisition. More specifically, it is related to face detection in digital image information.

### BACKGROUND OF THE INVENTION

Face detection is becoming ever more popular in digital cameras of today. One example is digital cameras that are able to detect a smiling face of a subject to be photographed before capturing a digital image of the subject. Other digital cameras are simply able to detect one or more human faces in their digital viewfinder.

Thus, by finding faces in the viewfinder image, the digital camera can have a more intelligent auto focus and focus on the faces that are detected.

However, one problem with face detection is that it only finds faces that are “standing up.” Hence, it does not detect upside down faces, or faces that are “sideways” or otherwise rotated. Especially when a user of the digital camera turns the camera (for example to take a portrait image) this becomes a problem, since the faces now appear sideways to the camera. The face detector can no longer detect the faces. This means that the face detection auto focus will only work when holding the camera horizontally.

### SUMMARY OF THE INVENTION

Aspects described herein provide an image acquisition device comprising: an image sensing unit for registering raw image data; a movement sensing unit for determining information indicative of the current position of the image sensing unit and of a deviation of the current position of the image sensing unit from a reference position; a processing unit for receiving the information indicative of the current position of the image sensing unit and of its deviation from a reference position from the movement sensing unit, wherein the processing unit is adapted for moving image data received from the image sensing unit to the current position by the amount of deviation from its reference position determined by the movement sensing unit and for performing object recognition on the thus moved image data.

In this fashion, objects of interest may be detected by the processing unit regardless of the orientation of the image acquisition device.

The image acquisition device according to the present invention may additionally comprise a memory for storing the reference position of the image sensing unit. Here, information indicative of a reference position of the image sensing unit may be pre-stored.

In one example, the reference position may be expressed in terms of coordinates in a two-dimensional coordinate system. Also, the deviation of the current position of the image sensing unit from a reference position may comprise an angle of rotation. This may be the angle by which a user of the image acquisition device has rotated the image acquisition device from its reference position.

Furthermore, the image acquisition device may comprise a display unit for displaying image data acquired by the image sensing unit. In addition, the objects recognized by the processing unit may be visually enclosed by a geometrical figure, such as a square, a rectangle, a triangle, a circle or some other suitable geometrical shape.

Moreover, the image acquisition device according to the present invention may comprise a receiver/transmitter combination for communication in a wireless communication network. In this fashion, image data acquired by the image sensing unit may be uploaded to a server facility located in the wireless communication network or outside of it.

Also, the processing unit in the image acquisition device of the present invention may be adapted for converting raw image data received from the image sensing unit into color image data displayable on the display unit. Usually, the image data received from the image sensing unit represents raw image data giving information about light intensity in three color channels, i.e., the red, green and the blue channel, which is the so called RGB data. This information needs to be converted into color image information visible to the human eye.

Additionally, the processing unit may be adapted for rotating the image data. Especially if a user of the image acquisition device has moved or rotated the image acquisition device, the processing unit may follow the rotation of the image acquisition device by corresponding rotation of the image data from the image sensing unit to the new position.

In this new position, the processing unit may then perform object recognition operations in order to, for example, discover human or animal faces or other objects of interest.

These objects may then be enclosed. For example, the processing unit may then be adapted to enclose these objects using one of the geometrical shapes mentioned above.

Having enclosed the objects of interest in the acquired image data, the processing unit may instruct optical unit of the image acquisition device to perform auto focusing on these objects and thereby provide a more flexible and intelligent auto focus functions.

Another aspect of the present invention is related to a method for object recognition comprising the steps: receiving raw image data from a sensing unit; receiving information indicative of an actual position of the sensing unit and of its deviation from a reference position; moving image data received from the sensing unit to the actual position by an amount defined by the deviation of the image sensing unit from a reference position and performing object recognition on the thus moved image data.

The method is especially suited to be implemented by an image acquisition device according to the present invention described earlier.

Another aspect of the present invention is related to a computer program for object recognition comprising instruction sets for: receiving raw image data from a sensing unit; receiving information indicative of an actual position of the sensing unit and of its deviation from a reference position; moving image data received from the sensing unit to the actual position by an amount defined by the deviation of the image sensing unit from a reference position; and performing object recognition on the thus moved image data.

It should be pointed out that the computer program is especially suited to be executed in a memory of the image acquisition device described earlier, executing the method steps of the method for object recognition according to the present invention.

Various advantages of the present invention will become more apparent by studying the following detailed description together with the accompanying drawings.

### BRIEF DESCRIPTION OF THE DRAWINGS

FIG. 1a illustrates face recognition through a digital viewfinder of a digital camera according to known technology.

FIG. 1b illustrates views through a digital viewfinder of a digital camera when the camera is held essentially in portrait mode.

FIG. 1c illustrates views through a digital viewfinder of a digital camera when the camera is held in a position between the landscape and portrait modes.

FIG. 2 illustrates an image acquisition device according to one embodiment of the present invention.

FIG. 3a illustrates face recognition through a digital viewfinder of a digital camera according one embodiment of the present invention, when the digital camera is held in portrait mode.

FIG. 3b illustrates face recognition through a digital viewfinder of a digital camera according one embodiment of the present invention, when the digital camera is held in a position between the landscape and the portrait mode.

FIG. 4 illustrates the steps of a method according to one embodiment of the present invention.

### DETAILED DESCRIPTION OF PREFERRED EMBODIMENTS

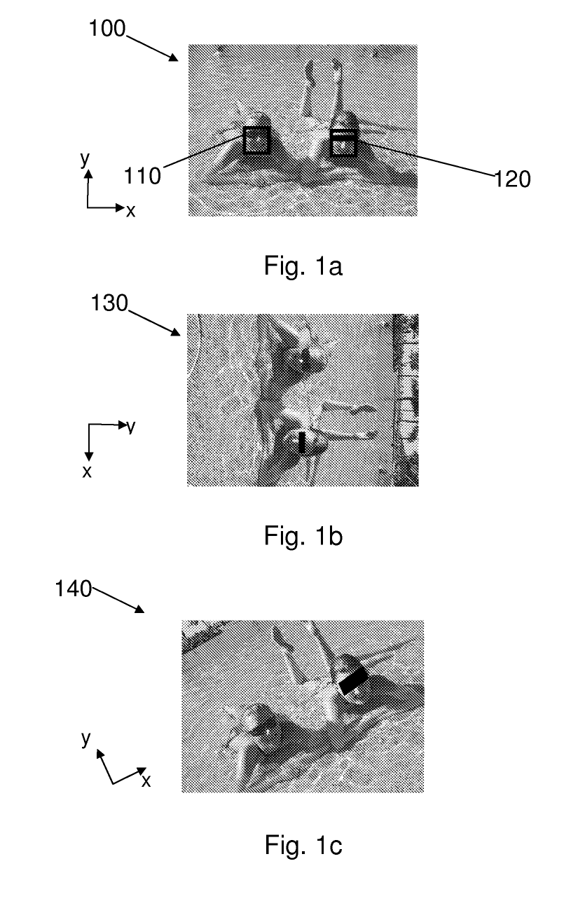

FIG. 1a shows a view 100 seen from a viewfinder of an image acquisition device according to known technology, such a digital camera (not shown). Here, image acquisition device is held in landscape mode. We may, for example, define the landscape mode as the position in which the x-axis displayed in FIG. 1a is the horizontal axis, while the y-axis is the vertical axis and where the digital viewfinder is rotated by an angle by at most ±5° in the x-y-plane as depicted by the axes in the figure. Since the orientation of the image in the digital viewfinder is related to the orientation of an image sensing unit in the image acquisition device, we will consider the rotation of the digital viewfinder and the rotation of the image sensing unit as equal. It should be noted here that the x and y-axes in the figure are the axes of the image sensing unit and also the digital viewfinder of the image acquisition device.

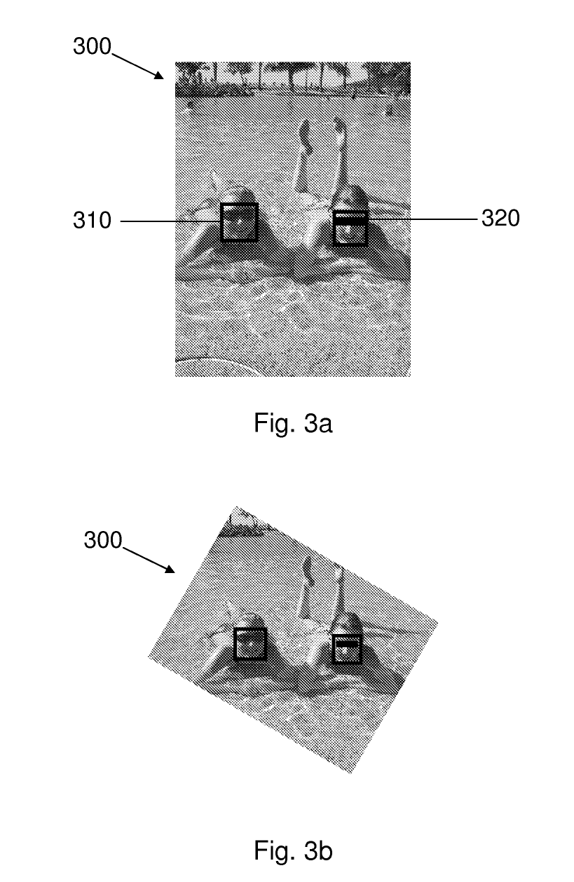

Two human faces have been detected indicated by the black squares 110 and 120 surrounding them. Details of human face detection algorithms will not be elaborated here, since they are known to the skilled person. It should also be noted that the black rectangle over the eyes of one of the subjects in FIG. 1a (and also shown in FIGS. 1b, 1c, 3a and 3b) is merely done to obscure the subject's face and is not an actual rectangle that is produced by the image acquisition device.

FIG. 1b illustrates the situation when the digital viewfinder and thereby the image sensor of the image acquisition device is held in portrait mode, i.e., rotated by essentially ±90° in the x-y-plane. In this particular case, the image sensing unit has been rotated by −90° in the x-y-plane. Due to the rotation into portrait mode, the x-y axes of the image sensor have changed their position to the one depicted in FIG. 1b. Hence, without compensation for the rotation of the image sensing unit, the resulting image 130 seen through the viewfinder would look like the image depicted in FIG. 1b. Known image processing algorithms for face detection are not adapted for detecting human faces in such a situation and therefore, the image acquisition devices according to known technology will have difficulty detecting human faces in the image acquired by the image sensing unit.

FIG. 1c illustrates, similarly to the case in FIG. 1b, the situation when the digital viewfinder and thereby also the image sensing unit of the image acquisition device are held in a position between the landscape mode and the portrait mode, i.e., where they have been rotated in the paper plane by an angle which, for example, is greater than ±5°.

Such an image registered by the image sensing unit will making it difficult if not impossible for current image processing algorithms to recognize human faces or smiles in the image.

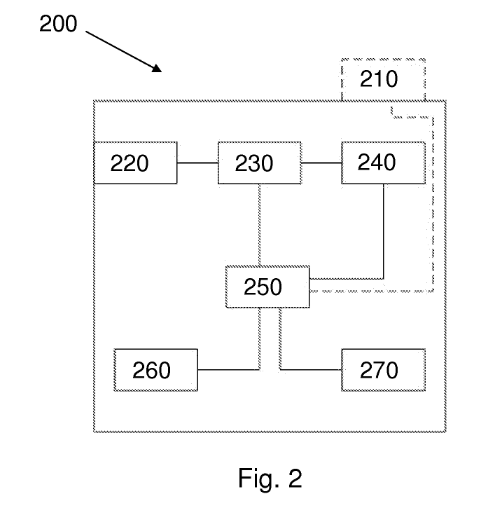

Turning now to FIG. 2, an image acquisition device 200 according to one embodiment of the present invention is illustrated.

The image acquisition device comprises an optical unit 220 connected to an image sensing unit 230, which, in turn, is connected to a processing unit 250. Also, the processing unit 250 is connected to a display unit 240, a movement sensing unit 260 and a memory 270. The movement sensing unit 260 is also connected to the image sensing unit 230.

Using the optical unit 220, the image acquisition device 200 is able to register optical data in the field of view of the optical unit 220. Usually, the optical unit 220 comprises a lens, such as a fixed- or variable focal length lens. Also, as is known to the skilled person, the optical unit 220 may also comprise a lens equipped with an anti-vibration mechanism to compensate for involuntary and unwanted movements of the image acquisition device 200 during image capturing.

The optical data registered by the optical unit and supplied in analog form is converted into raw image data present as digital intensity data by the image sensing unit 230. In present image sensing units, the intensity data is usually present for three color channels, i.e., red, green and blue.

However, other ways of organizing the intensity information may be used in order to create color information from the raw image data depending on the type of image sensing unit. In the image acquisition unit 200 according to one embodiment of the present invention, the image sensing unit 230 may comprise a CCD (Charge Coupled Detector)- or CMOS (Complementary Metal Oxide Semiconductor)-based image sensing unit. However, other sensing units may also be used.

Using the raw data from the image sensing unit 230, the processing unit 250 is adapted to convert the raw data into a color digital image displayed on the display unit 240. This color digital image may then be a more or less accurate real-time reflection of what the optical unit 220 “sees”. Thus, as known to the skilled person, a user of the image acquisition unit 200 may obtain a more or less accurate idea of the final result of the image acquisition before deciding to acquire the optical image registered by the optical unit 220.

Moreover, the processing unit 250 of the image acquisition device 200 is adapted for performing image processing algorithms on the image data converted from the raw image data registered by the image sensing unit 230. As already mentioned earlier, the processing unit 250 of the image acquisition device 200 is also in communication with a movement sensing unit 260. The movement sensing unit 260 is adapted for detecting the orientation of the image sensing unit 230 caused by the user movement of the image acquisition device 200. One way of supplying orientation information is to register the actual coordinates for the image sensing unit 230 in a reference two-dimensional coordinate system (such as the x-y coordinate system depicted in FIG. 1a) compared to reference coordinates indicative of the reference position for the image sensing unit 230. Such a reference position may, for example, be indicative of the “landscape” position of the image sensing unit 230. There are many ways in which such a movement sensing unit 260 may be realized. One way of implementing it may be in the form of two accelerometers, one for the horizontal and one for the vertical axis. These accelerometers may then detect the total external force exerted on the accelerometer. A reference position for the image sensing unit 230 may then be defined as the position in which the accelerometer for the horizontal axis detects only the earth's gravity as the external force and where the gravity is perpendicular to the longitudinal direction of the accelerometer, while the gravity for the accelerometer for the vertical axis is directed in the longitudinal direction of that accelerometer. It is also possible to only use one accelerometer to determine the orientation of the image sensor. Details about the functioning principle of an accelerometer will not be elaborated here, since they are known to the skilled person. However, other types of movement sensing units may be used, such as gyroscopes, for example.

Hence, the processing unit 250 is adapted to receive the actual coordinates from the movement sensing unit 230 indicative of the actual position of the image sensing unit 230. By comparing these coordinates with the reference coordinates of the image sensing unit 230 indicative of the “resting position,” the processing unit 250 may detect the orientation of the image sensing unit 230 and thereby also determine the rotation angle of the image sensing unit 230.

Also, the processing unit 250 may then be adapted to rotate the color image data converted from the raw image data received from the image sensing unit 230 to the actual position of the image sensing unit 230. In the actual position, the processing unit 250 may be adapted to perform human and animal face recognition algorithms which are, per se, known to the skilled person. In one variant of the embodiment in FIG. 2, the processing unit 250 of the image acquisition unit 200 may be adapted to perform the face recognition by, for example, calculating the amount of deviation of the areas identified as likely to be human or animal faces from a list of candidate images displaying human or animal faces which may be pre-stored in the memory 270 of the image acquisition device 200. Depending on the size of the memory 270 and the face recognition algorithm used, this list may comprise only a few candidate images or a large number of images. Also, the degree of deviation calculated may be determined according to different methods, such as maximum likelihood, least squares method or some other known methods. Once the processing unit 250 has determined a match between the areas identified in the rotated raw image and the list of candidate images, the processing unit 250 may be adapted to enclose those areas in the raw image data by coordinates indicative of a geometrical shape, such as a square, a rectangle, a triangle or some other shape suitable for marking out areas in the raw image data.

At the same time, the processing unit 250 may rotate the visual data displayed on the display unit 240 in order to match the angle of rotation of the image data with the actual angle by which a user of the image acquisition device 200 has rotated the image sensing unit. This is per se known to the skilled person. However, the processing unit 250 of the present invention may also visibly mark or identify the human or animal faces identified in the converted image data displayed in the display unit 240 by means of the geometrical shapes mentioned above.

In this fashion, human or animal faces may be identified from the raw image data supplied from the image sensing unit 230 regardless of the orientation of the image sensing unit 230. Hence, the image sensing unit 230 may be rotated from its reference position to a vertical or portrait position (±90°), to an upside-down-position (±180°-rotation) or some other angle between 0° and 360° without affecting the accuracy of the human or animal face recognition algorithms.

The face recognition according to the present invention may be especially suited for using it with existing auto-focus mechanisms in known image acquisition devices, thus allowing the user to always obtain a more precise automatic focus of the optical unit 220 onto human or animal faces seen in the display unit 240 regardless of the orientation of the image sensing unit 230 before deciding to acquire an image. It should be mentioned here, that the present image acquisition device 200 is not only limited to recognizing human or animal faces, but also any other objects of interest, such as cars, sports equipment, such as rackets, balls, goals as well as buildings and so on. In one variant of the image acquisition device according to the present invention, the user may select which objects he is primarily interested in focusing on before he decides to acquire an image. Such objects may be selected from a pre-stored list of objects provided to the user via a user interface (UI), entered manually via an input device (e.g., a keypad or keyboard) or by some other mechanism. Objects captured by in the view finder of the image acquisition device 200 may then be compared to candidate images associated with the selected objects of interest that are stored in memory 270.

Moreover, the processing unit 250 may also be adapted to add information about the angle of rotation for an acquired image into an image file before it is stored into the memory 270 of the image acquisition device 200.

Moreover, it may be pointed out that the image displayed by the display unit 240 may be an image quickly processed from the original raw image data supplied by the image sensing unit 230, such as is known to the skilled person.

Additionally, the image acquisition device 200 may also comprise a transmitter/receiver combination 210 by means of which the image acquisition device is able to communicate in a wireless communication network. Such a transmitter/receiver combination 210 may be useful in uploading one or more images acquired by the image acquisition device 200 to a server unit located either in or outside a wireless communication network for storage.

Proceeding to FIG. 3a, an image acquired by an image acquisition device, such as image acquisition device 200, is displayed, where its image sensing unit 230 of the image acquisition unit has been rotated by 90°. Using the movement sensing unit, such as the movement sensing unit 260 from FIG. 2, the processing unit 250 of the image acquisition device has detected the rotation of the image sensing unit 230 of the image acquisition device and rotated the image data converted from raw image data supplied by the sensor to the actual position of the image sensing unit 230. In this actual position, the processing unit 250 may then perform pattern recognition algorithms and recognize two human faces which then were marked or identify by two geometrical shapes 310 and 320. Thereafter, the processing unit 250 has enclosed the recognized human faces 310 and 320 in the image data by geometrical shapes and marked or displayed them in the display unit 240 of the image acquisition device. Thus, even though a user of the image acquisition device has rotated the image sensing unit by −90° into the portrait mode, the processing unit 250 is still able to recognize two human faces.

In FIG. 3b, an image acquired by the same image acquisition device as in FIG. 3a displaying the same motive as in FIG. 3a, where a user has rotated the image sensing unit 230 to the right by an angle between 0 and 90°, i.e., between the landscape and the portrait mode.

Even in this case, the processing unit 250 detected the rotation angle from the data supplied from the movement sensing unit 260, rotated the image data by the same angle to the actual position of the image sensing unit 230, performed face recognition algorithms and discovered two human faces. These faces were enclosed by two geometrical shapes and displayed by the squares 310 and 320 in the display unit 240 of image acquisition device 200, as illustrated in FIG. 3b.

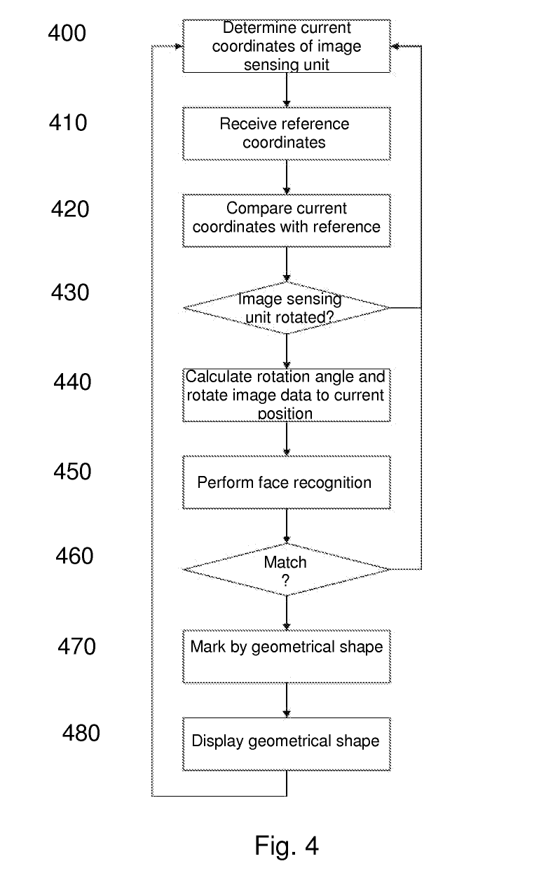

Turning now to FIG. 4, the method steps of a method for image acquisition according to the present invention are displayed in the form of a flowchart.

At step 400, a movement sensing unit, such as the movement sensing unit 260 in FIG. 2 detects movement of the image sensing unit, such as the image sensing unit 230 in the image acquisition device 200 in FIG. 2. The movement sensing unit 260 may do this by means of accelerometers using one accelerometer per axis. Thus, in a two-dimensional coordinate system which may be used in one variant of the present invention, two such accelerometers will be needed. However, movement may also be detected by a gyroscope, in which case only one gyroscope may be needed. Depending on cost aspects, accelerators, gyroscope or other movement sensing units may be used.

In the following step, at 410, the movement sensing unit 260 retrieves reference coordinates for the image sensing unit 230 indicative of a reference position for the image sensing unit 230. Preferably, this reference position may be the horizontal or landscape position of the image sensing unit and defined as in FIG. 1a. Reference coordinates may be predefined and pre-stored in the movement sensing unit 260 or retrieved from a memory, such as the memory 270 in the image acquisition device 200 of FIG. 2.

Thereafter, at step 420, the movement sensing unit 260 compares the actual coordinates determined with the reference coordinates received at step 410 and determines the relative position of the image sensing unit 230. Also, the movement sensing unit 260 transmits the information indicative of the relative position of the image sensing unit 230 to the processing unit of the image acquisition device, such as processing unit 250 illustrated in FIG. 2.

At step 430, the processing unit 250 detects from the information indicative of the relative position of the image sensing unit 230 whether the image sensing unit 230 has been rotated from the reference position. By rotation in this embodiment of the method, a rotation in a two-dimensional coordinate system, such as the one defined in FIG. 1a is meant.

In instances where the image sensing unit 230 has not been rotated out of the reference position, the image sensing unit 230 simply continues detecting movement and direction of the image sensing unit 230 at step 400. It should be mentioned here that the image sensing unit 230 may wait a predefined amount of time before comparing the actual coordinates with the reference coordinates of the image sensing unit 230 in step 430. In this fashion, more stable and reliable coordinates for the actual position of the image sensing unit 230 may be obtained.

However, if at step 440, the processing unit 250 has detected that the image sensing unit 230 has been rotated more than a certain minimum angle (for example more than ±5°), it proceeds to calculate the rotation angle from the reference coordinates and the relative position of the image sensing device. Also, at step 440, the processing unit 250 rotates the image data received from the image sensing unit 230 to the actual position of the image sensing unit 230 of the image acquisition device by the calculated angle. The mechanism of rotation of image data is known to the skilled person and will not be elaborated further in the text.

At the next step, at 450, the processing unit 250 may perform face recognition on the image data rotated to the reference position. Face recognition may be performed in a number of different ways. One way of performing it is by retrieving a number of candidate human or animal faces from a list pre-stored in the memory of the image acquisition device. This list may be longer or shorter depending on the face recognition algorithm used. Another face recognition technique may be implemented by looking for certain features characteristic of a human or animal face, such as eyes, nose, mouth and the relative position of these compared to one standard human or animal faces.

However, the present method of face recognition is not only limited to face recognition. It may also work for recognition of any object of interest. These objects may be predefined in the image acquisition unit 200 and selected by the user.

In case a match with a human or animal face is detected at step 460, the processing unit 250 proceeds to step 470 where it encloses the area recognized as human or animal face by a geometrical shape, such as a square, a rectangle, a triangle, a circle or any other geometrical shape suitable for enclosing the recognized face in the image data.

In the last step, at 480, the processing unit 250 displays the geometrical shape around the areas identified at step 470 in the display unit of the image acquisition device, such as the display unit 240. The processing unit 250 may then also proceed to auto focus on these areas in the image enclosed by the geometrical shapes (not shown).

On the other hand, in case no match has been found, the processing unit 250 instructs the movement sensing unit 260 to continue detecting movement and direction of movement of the image sensing unit 230 at step 400.

It is worth pointing out here that a match between an area of the image data and candidate face or a reference face may be defined as a value in the maximum likelihood or in the least squares sense or as a predefined value according to some other face recognition method known by the skilled person.

Also, as already pointed out earlier, the image recognition method according to the present invention may also comprise other objects than merely human and animal faces, such as sports equipment, i.e., balls, rackets, goals or other objects, as desired.

It should be emphasized that the term “comprises/comprising” when used in this specification is taken to specify the presence of stated features, integers, steps, or components, but does not preclude the presence or addition of one or more other features, integers, steps, components, or groups thereof.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

Additionally, it should also be mentioned that the present invention should not be construed as limited by the above elaborated embodiments. It will be possible for a skilled person who has studied the above description to contemplate other possible embodiments of the present invention. Ultimately, the present invention is only limited by the spirit and scope of the accompanying claims and their equivalents.

1. An image acquisition device, comprising:
an image sensing unit for registering raw image data;
a movement sensing unit for determining information indicative of a current position of the image sensing unit and of a deviation of the current position of the image sensing unit from a reference position; and
a processing unit for receiving the information indicative of the current position of the image sensing unit and its deviation from a reference position from the movement sensing unit,
wherein the processing unit is adapted for moving image data received from the image sensing unit to the current position by the amount of deviation from its reference position determined by the movement sensing unit and for performing object recognition on the moved image data.

2. The image acquisition unit according to claim 1, wherein the image acquisition device further comprises a memory for storing the reference position of the image sensing unit.

3. The image acquisition unit according to claim 1, wherein the image acquisition device further comprises a display unit for displaying image data acquired by the image sensing unit.

4. The image acquisition unit according to claim 1, wherein the image acquisition device further comprises a receiver/transmitter combination for communication in a wireless communication network.

5. The image acquisition unit according to claim 1, wherein the information indicative of the current and reference position of the image sensing unit comprises coordinates in a two-dimensional coordinate system.

6. The image acquisition unit according to claim 1, wherein the deviation of the current position of the image sensing unit from a reference position comprises an angle of rotation.

7. The image acquisition unit according to claim 3, wherein the processing unit is adapted for converting raw image data received from the image sensing unit into color image data displayable on the display unit.

8. The image acquisition unit according to claim 1, wherein the processing unit being adapted for moving the image data received from the image sensing unit comprises the processing unit being adapted for rotating the image data.

9. The image acquisition unit according to claim 1, wherein the processing unit being adapted for performing object recognition on the moved image data comprises human or animal face recognition.

10. The image acquisition unit according to claim 1, wherein the processing unit is further adapted for enclosing one or more objects recognized during object recognition on the moved image by a geometrical shape.

11. The image acquisition unit according to claim 10, wherein the processing unit is further adapted for displaying the one or more geometrical shapes around the enclosed object in a display unit of the image acquisition device.

12. The image acquisition device according to claim 1, wherein the processing unit is adapted for instructing an optical unit in the image acquisition device for performing automatic focusing on the objects recognized during the object recognition.

13. A method for object recognition comprising:
receiving raw image data from a sensing unit;
receiving information indicative of an actual position of the sensing unit and of its deviation from a reference position;
moving image data received from the sensing unit to the actual position by an amount defined by the deviation of the image sensing unit from the reference position; and
performing object recognition on the moved image data.

14. The method of claim 13, further comprising:
enclosing objects recognized during the object recognition step by a geometrical figure and displaying the geometrical figure around the recognized objects.

15. The method of claim 13, wherein the method further comprises:
performing automatic focusing on the objects recognized during the object recognition step.

16. A computer program for object recognition comprising instruction sets for:
receiving raw image data from a sensing unit;
receiving information indicative of an actual position of the sensing unit and of its deviation from a reference position;
moving image data received from the sensing unit to the actual position by an amount defined by the deviation of the image sensing unit from a reference position; and
performing object recognition on the thus moved image data.
